(19) United States
(12) Patent Application Publication
(10) Pub. No.: US 2020/0038282 A1
(43) Pub. Date: Feb. 6, 2020

(54) THERAPEUTIC, FITNESS, AND SPORTS ENHANCEMENT APPARATUS

(71) Applicant: Active Life Solutions, LLC., Waynesboro, PA (US)

(72) Inventor: Stephen BUI, Waynesboro, PA (US)

(73) Assignee: Active Life Solutions, LLC., Waynesboro, PA (US)

(21) Appl. No.: 16/531,322

(22) Filed: Aug. 5, 2019

Related U.S. Application Data
(60) Provisional application No. 62/714,197, filed on Aug. 3, 2018.

(51) Int. Cl. A61H 7/00; A61H 15/02; A61H 39/04

(52) U.S. Cl. CPC A61H 7/002; A61H 15/02; A61H 2015/0014; A61H 2201/0207; A61H 2201/0214; A61H 39/04

(57) ABSTRACT

A device for therapeutic, fitness and sports enhancement can include an elongated apparatus body. The apparatus body can include three or more rounded and/or sharp edges connected by curvilinear surfaces between each of the edges about a longitudinal axis of the apparatus body. The device may or may not also include multiple projections along the outer surface of the apparatus body that are configured to be applied to the user of the device.

### RELATED APPLICATIONS

This application claims priority under 35 U.S.C. § 119 to U.S. Provisional Patent Application No. 62/714,197 filed Aug. 3, 2018, and titled “THERAPEUTIC, FITNESS, AND SPORTS ENHANCEMENT APPARATUS,” the entire contents of which are hereby incorporated herein by reference for all purposes.

### FIELD OF THE INVENTION

Generally, the present invention relates to sports equipment, massage equipment, therapeutic equipment and physiotherapy equipment as well as equipment for myofascial pain therapy. Particularly, however not exclusively, the present invention pertains to a self-massage apparatus for the sole of foot.

### BACKGROUND

Muscle maintenance of athletes and persons in general acompasses a myriad of active and passive measures directed to accelerate a person's physical and mental recovery after physical exercise, to prevent acute and strain injuries, to attain an optimal relaxation and to enable a person to adopt an economic, efficient and an injury preventative way of exercising her body.

Various apparatuses have been used for massaging, exercising and stretching the soles of feet for example in order to treat plantar fasciitis. Additionally, medication, steroids and shock-wave therapy are used.

Some known prior art solutions comprise cryotherapy apparatuses such as ice bags, ice buckets and coolable sole apparatuses. For massaging the sole, use of tennis balls and foam rollers is also common. Ball-like rollers and tube-like rollers are usually operated by rolling the roller part against the sole of the foot with hand or against a surface.

The method of rolling a flexible roller against the sole of the foot has the commendable goal of stimulating the metabolism and stretching of exercised muscular groups and to massage the muscles, tendon, ligaments and articulations of the sole of foot. While widely used and often portable, light and convenient, this category of exercise rollers finds a somewhat narrow field of application because of the limited exercise positions they provide.

### SUMMARY OF THE INVENTION

The objective of the embodiments of the present invention is to at least alleviate one or more of the aforementioned drawbacks evident in the prior art arrangements particularly in the context of massage apparatuses for the feet. The objective is generally achieved with an apparatus in accordance with the present disclosure.

An advantage of the present invention is that it allows for at least two positions for treatment for the sole of the foot and other soft tissue parts of the body. The therapeutic apparatus is aimed at multi-modal treatment such as massaging, stretching and trigger point therapy. Additionally the apparatus may comprise heat-treating means.

In accordance with one aspect of the present invention a therapeutic, fitness and sports enhancement apparatus comprising an elongated body with three or more rounded and/or sharp edges connected by curvilinear surfaces between said edges about a longitudinal axis with or without plurality of projections on the surfaces.

The apparatus may be used manually without supports, such as by hand, or with a support, to produce a dragging stimulation to soft tissue, such as that the apparatus body is moved and pressed against soft tissue of the body without revolving the apparatus body around its longitudinal axis during the dragging motion. For example, the apparatus body may be used to stimulate the soft tissue in the sole of the foot, hip, thigh, neck, forearm and hamstring areas but it is clear that it may be used for any soft tissue of the body reachable from outside the human body.

As briefly reviewed hereinbefore, the utility of the different aspects of the present invention arises from a plurality of issues depending on each particular embodiment.

The expressions “apparatus body” and “elongated body” are herein used to refer to the unit which may be used independently or with other parts as described in the application to stimulate soft tissue of an animal body, preferably human body.

The expression “a number of” may herein refer to any positive integer starting from one (1). The expression “a plurality of” may refer to any positive integer starting from two (2), respectively.

The term “exemplary” refers herein to an example or example-like feature, not the sole or only preferable option.

Different embodiments of the present invention are also disclosed in the attached dependent claims.

### BRIEF DESCRIPTION OF THE DRAWINGS

Some exemplary embodiments of the present invention are reviewed more closely with reference to the attached drawings, wherein

FIGS. 1a and 1b depict an embodiment of the apparatus in accordance with the present invention,

FIGS. 2a and 2b depict another embodiment of the apparatus in accordance with the present invention,

FIGS. 3a and 3b depict another embodiment of the apparatus in accordance with the present invention,

FIGS. 4a and 4b depict another embodiment of the apparatus in accordance with the present invention,

FIGS. 5a and 5b depict the support attachment means for the apparatus body in accordance with an embodiment of the apparatus of the present invention,

FIGS. 6a and 6b depict the support underside in accordance with an embodiment of the apparatus of the present invention.

### DETAILED DESCRIPTION OF THE EMBODIMENTS

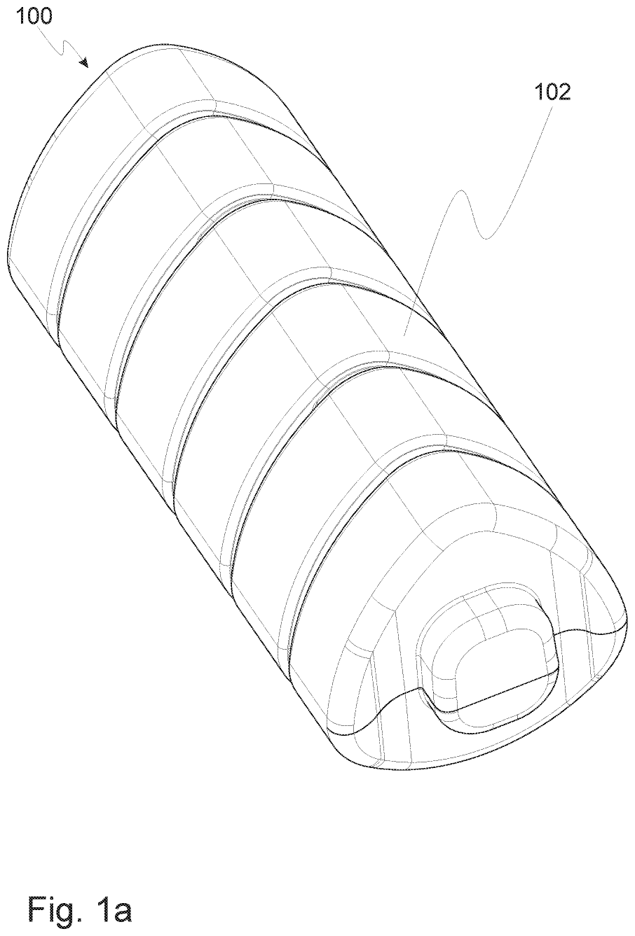

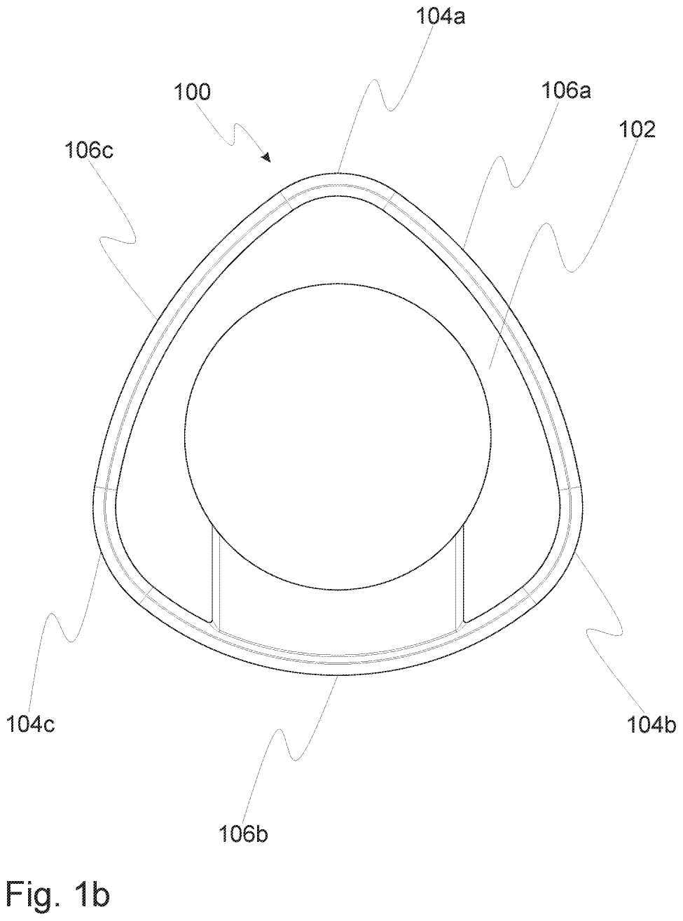

FIGS. 1a and 1b depict an embodiment of the apparatus (100) in accordance with the present invention.

The apparatus (100) comprises an elongated body (102) with an essentially semi-triangular cross-section or Reuleaux triangle cross-section. The Reuleaux triangle shape may be defined by the intersection of three circular disks, each having its center on the boundary of the other two. The apparatus body (102) may have a Reuleaux cross-section with at least two variable surfaces. Optionally the cross-section width of the apparatus body (102) may be variable along the longitude of the apparatus body (102). The cross-section is defined by three curvilinear surfaces (106a, 106b, 106c) between three edges (104a, 104b, 104c) in a longitudinal direction of the apparatus body (102). The edges (104a, 104b, 104c) may be sharp or essentially round. The edges (104a, 104b, 104c) may be different from one another in terms of their “sharpness” and/or “roundness”. Preferably, the edges (104a, 104b, 104c) are continuous along the longitude of the apparatus body (102). At least two curvilinear surfaces (106a, 106b, 106c) may be different from each other by having different curvilinear trajectories, which enables the apparatus (100) to be used in at least two different positions wherein the curve-linear surfaces (106a, 106b, 106c) facing the user are different in shape.

The apparatus body (102) is preferably completely solid. Optionally, the apparatus body (102) may be hollow or partly hollow or comprise a number of hollow sections. Other structures and materials are possible e.g. for cooling and/or heating functionality. Preferably, the apparatus body (102) comprises soapstone. Some other feasible materials for the body (102) include rubber, foam material and plastic. The apparatus body (102) may comprise a plurality of materials such that e.g. the core comprises a first material and an overlay of a number of other materials.

For example, the apparatus body (102) may comprise solid soapstone or soapstone with a metal core on which a further overlay of rubber or foam coating may be produced for altered tissue mobilization of soft tissue.

The apparatus (100) may comprise projections on one or more of the surfaces (106a, 106b, 106c) of the apparatus body (102). The projections may be arranged for example on one curvilinear surface defined between two edges of any of the edges (104a, 104b, 104c). The projections may comprise a number of different shapes such as bumps, pebbles, grooves and/or spike shapes. A number of apparatus body (102) surfaces (106a, 106b, 106c) may comprise also different textures by an overlay material, material texture, projections and/or combination thereof.

The apparatus body (102) is suitable for the sole of the foot but it may be used for soft tissue of other human and animal body parts as well.

The apparatus (100) may be used by hand or it may be used against a surface. The curvilinear shape of the surface and the edges (104a, 104b, 104c) enable rubbing and dragging movement against the soft tissue of a user or towards another person if used by a person without revolving motion of the apparatus.

Clearly, the dimensions of the apparatus (100) may be scalable to a plurality of different dimensions. An example of feasible dimensions comprise longitudinal length of the apparatus body (102) of some 116 mm, cross-diameter between two edges of some 48.75 mm and another cross-diameter from third edge to the farthest point of the opposing (in a cross-section view) surface of some 50 mm.

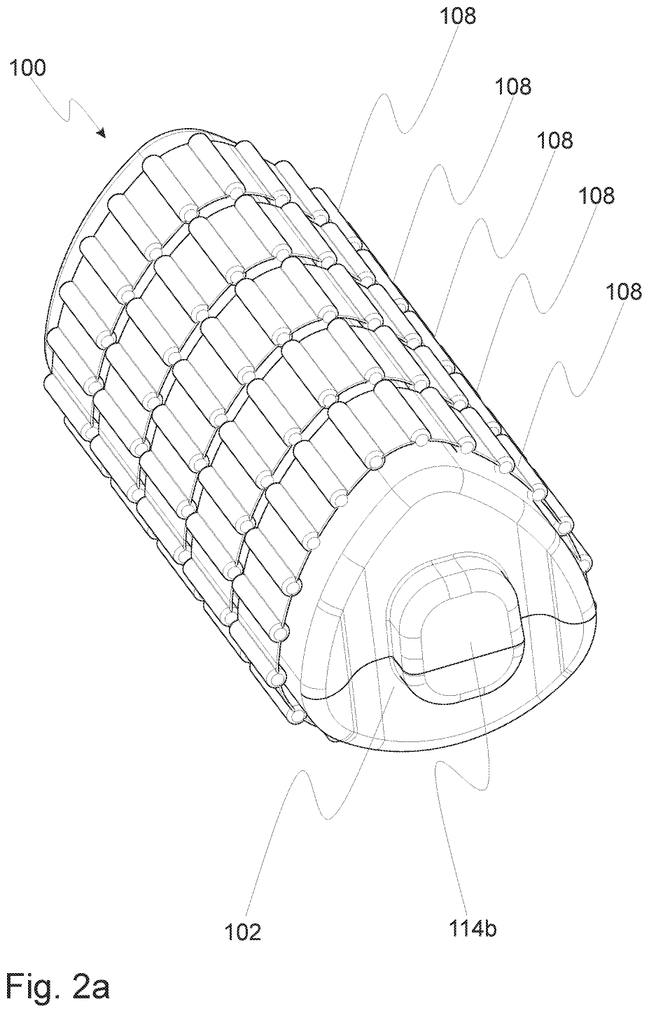

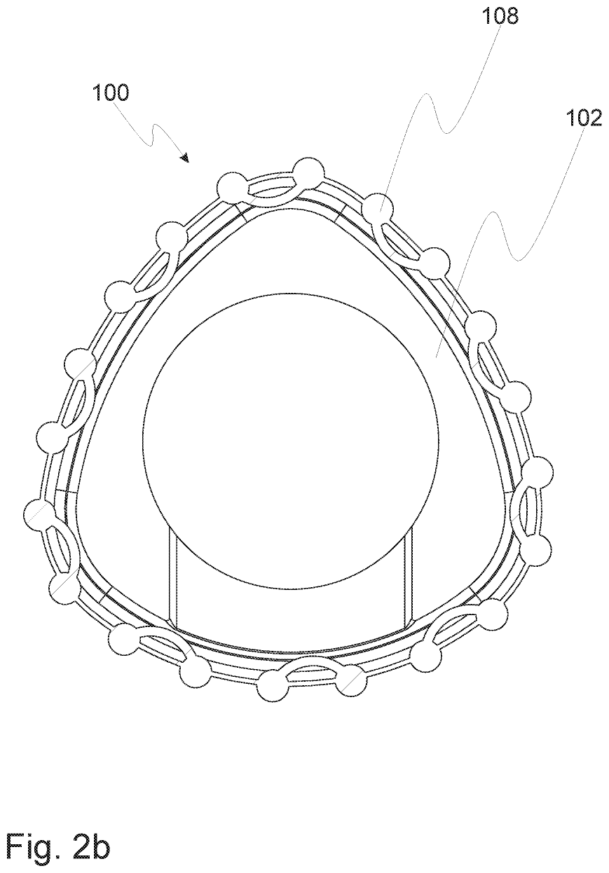

FIGS. 2a and 2b depict another embodiment of the apparatus (100) in accordance with the present invention.

The apparatus body (102) may be fitted with a fixed or movable sleeve or a plurality of sleeve parts (108) over the outer surfaces (106a, 106b, 106c) of the apparatus body (102). The one or more sleeve parts (108) may comprise a number of materials such as rubber, foam and plastic. Additionally or optionally the sleeves (108) may comprise a number of different shapes such as bumps, pebbles, grooves and/or spike shapes. The sleeves (108) may comprise also different textures via the overlay material, material texture, projections and/or combination thereof.

The one or more sleeves (108) may be arranged over the apparatus body (102), such that the sleeve or sleeve parts (108) may or may not revolve over the apparatus body (102). The sleeve or sleeve parts (108) may be essentially ring-shaped. The sleeve or sleeve parts (108) may comprise an inner diameter which is essentially the same or slightly bigger than widest outer diameter of the apparatus body (102).

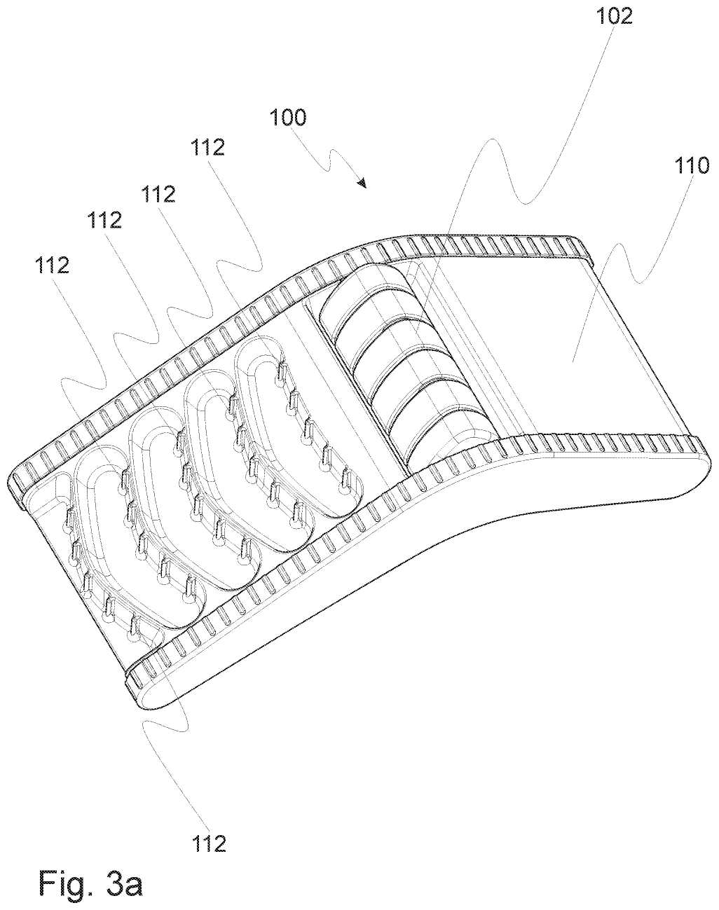

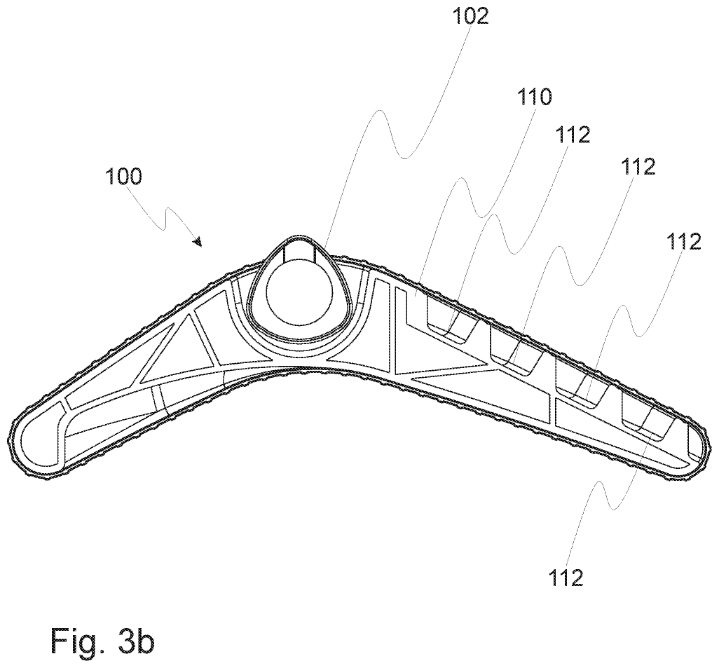

FIGS. 3a and 3b depict another embodiment of the apparatus (100) in accordance with the present invention.

The apparatus (100) may comprise a support (110), which enables the apparatus body (102) to be elevated and/or fixed to a number of positions. The support (110) may further comprise gripping means (112) for toes. This enables toes to drag onto the structures while curling of the toes makes the sole of the foot drag on a surface of the apparatus body (102). The gripping means (112) preferably comprise protrusions or extrusions in the support (110) at one or more sides of where the apparatus body (102) is fixed. Other means such as clamping means for the toes may be used.

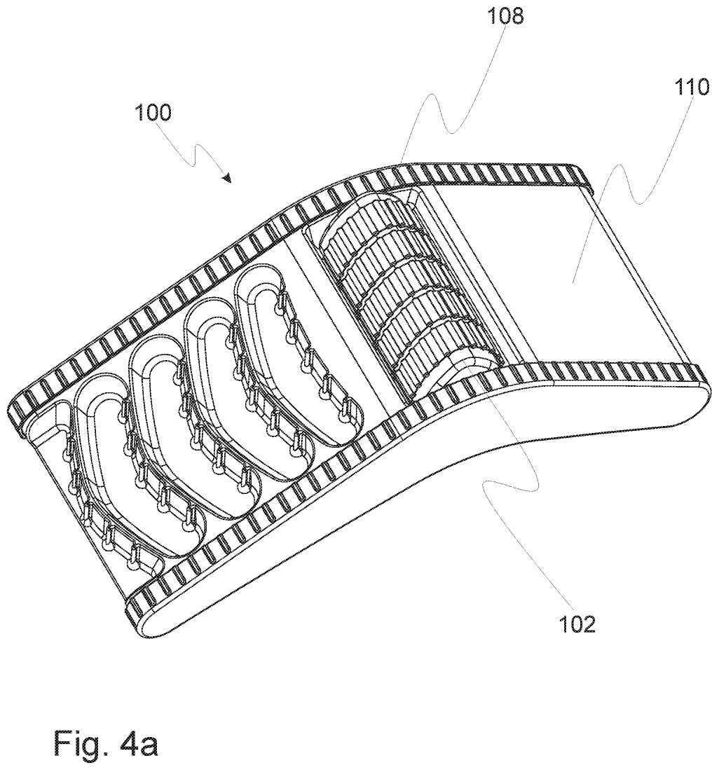

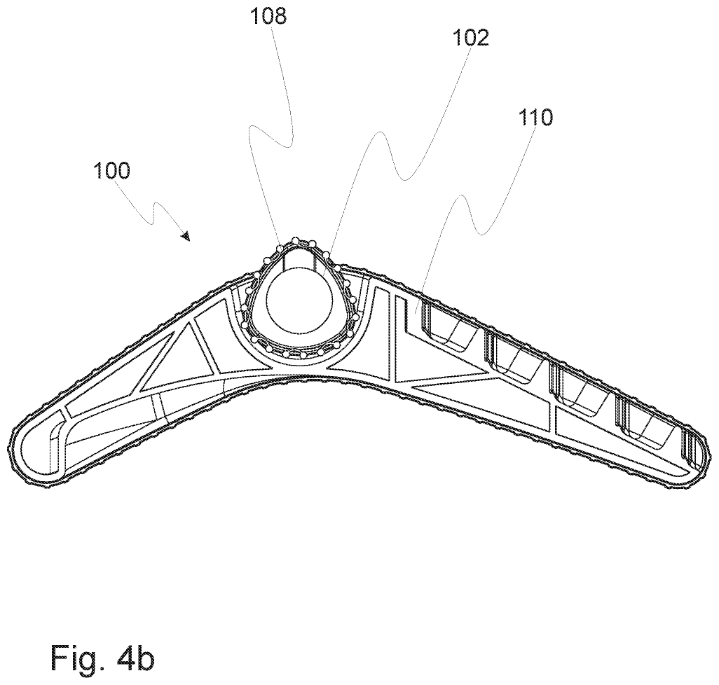

FIGS. 4a and 4b depict another embodiment of the apparatus (100) in accordance with the present invention. Herein, the apparatus (100) comprises a support (110), which enables the apparatus body (102) to be elevated and/or fixed to a number of positions with a plurality of sleeve parts (108) over apparatus body (102).

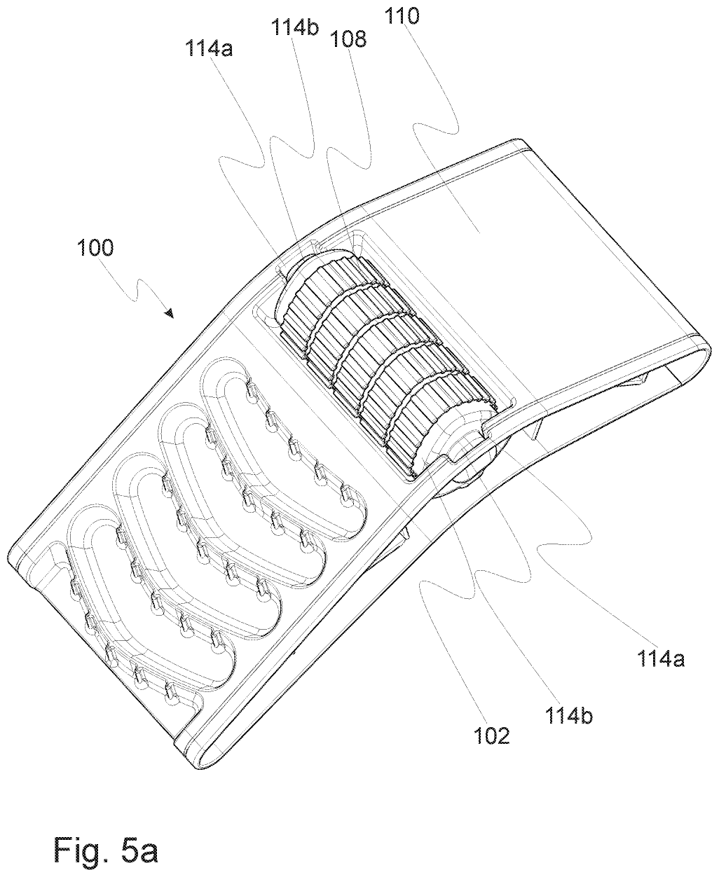

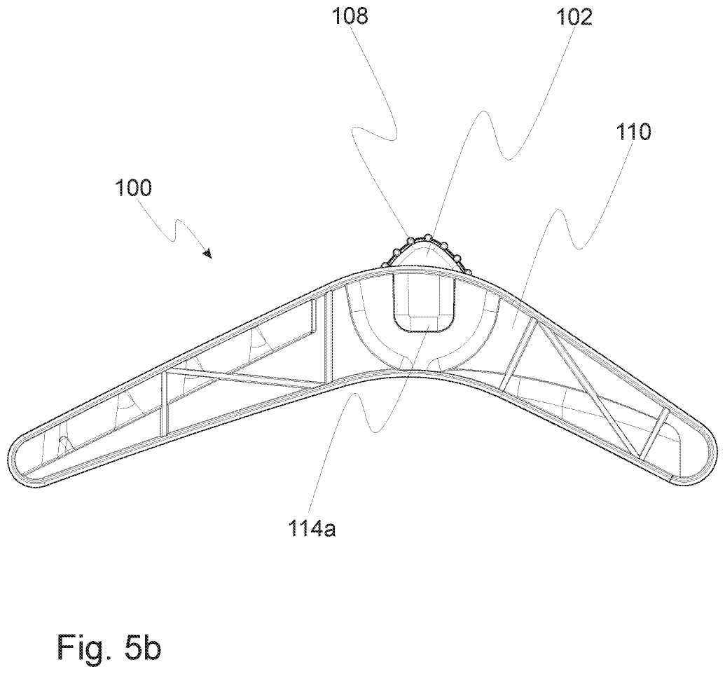

FIGS. 5a and 5b depict the support (110) attachment means for the apparatus body (102) in accordance with an embodiment of the apparatus (100) of the present invention.

The support (110) may comprise attachment means (114a, 114b) for attaching the apparatus body (102) to different positions. For example, the support (110) may comprise grooves (114a) and the apparatus body (102) may comprise additional protrusions (114b) at the longitudinal ends of the apparatus body (102), which protrusions (114b) may be inserted into the grooves (114a) for attaching or fixing the apparatus body (102) to a number of positions to the support (110). The protrusions (114b) at the longitudinal ends may comprise protrusions (114b) that have a triangular or rectangular cross-section shape. Correspondingly, the grooves (114a) will have substantially the same shape to fit the apparatus body (102) attachment protrusions (114b) therein.

Alternatively, the support (110) may comprise a cradle-like attachment means such as that the support (110) comprises a number of grooves with a shape corresponding to the apparatus body (102) to house the apparatus body (102) from the surfaces (106a, 106b, 106c) sufficiently therein without letting the apparatus body (102) move or revolve once fitted therein. The number of grooves (114a) act as mechanical fixing means, which lock the apparatus body (102) immovably to a position. Further, such attachment means are operable simply by inserting the apparatus body (102) into the support (110) and grooves (114a) therein. This enables the apparatus (100) to be used such that any surface or edge of the apparatus body (102) is dragged with pressure on a human body part or that part of the human body part is pressed and dragged across any part of the apparatus body (102) while the apparatus body (102) is fixed in the support (110). The apparatus body (102) isn't hence rotated during use although it may be made to rotate e.g. when used by hand without the support (110).

The support (110) may be used to fix the apparatus body (102) to a number of positions. The attachment means (114a, 114b) of the support (110) may hence determine the position of the apparatus body (102), in which case the apparatus body (102) may be symmetrical or non-symmetrical, or the attachment means (114a, 114b) of the support (110) may be such that the apparatus body (102) position is defined by inserting the apparatus body (102) to the support (110) attachment means (114a, 114b) into a preferred position. In other words, different apparatus body (102) positions may be achieved via a number of apparatus body (102) cross-section shapes and/or having a number of fixing positions in the support (110) attachment means.

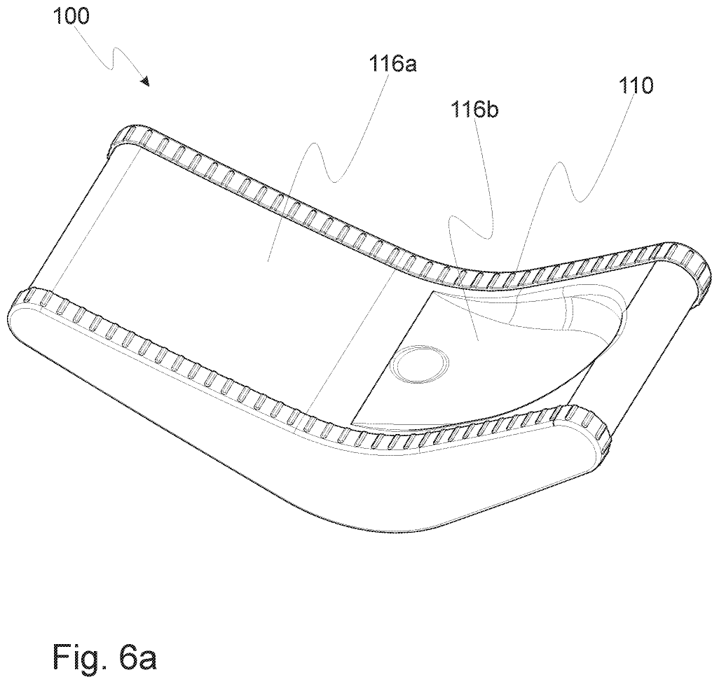

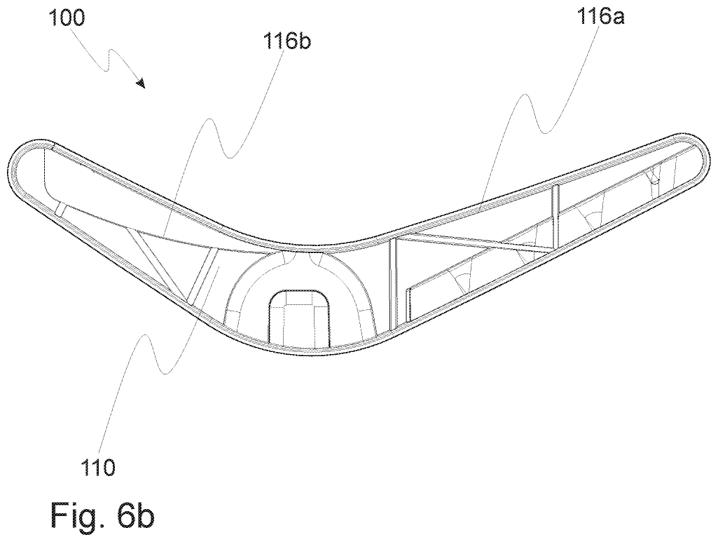

FIGS. 6a and 6b depict the support (110) underside in accordance with an embodiment of the apparatus (100) of the present invention.

The support (110) may comprise an additional structure at the underside for stretching the sole of the foot. The structure is preferably defined by at least two surfaces (116a, 116b) defined by an angle therebetween. The angle may be predetermined or a mechanical mechanism may be arranged therebetween to manipulate the angle.

The apparatus (100) is shown without the apparatus body (102), which is removed so that the support (110) may be placed against the surface with the underside of the support (110) facing the user.

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention.

What is claimed is:

1. A therapeutic, fitness and sports enhancement apparatus comprising: an elongated apparatus body with three or more rounded and/or sharp edges connected by curvilinear outer surfaces between said edges about a longitudinal axis with or without a plurality of projections on the outer surfaces.

2. The apparatus of claim 1, wherein the apparatus body comprises a fixed or movable sleeve or a plurality of sleeve parts fitted over the outer surfaces of the apparatus body.

3. The apparatus of claim 1, wherein the apparatus body comprises a heatable or a coolable material.

4. The apparatus of claim 1, further comprising a support.

5. The apparatus of claim 4 wherein the support comprises attachment means for attaching the apparatus body to the support in at least two different positions about the longitudinal axis of the apparatus body.

6. The apparatus of claim 5 wherein the attachment means fix the apparatus body immovably to the support so that the apparatus body does not revolve around its longitudinal axis.

7. The apparatus of claim 1, wherein the apparatus body comprises soapstone.

8. The apparatus of claim 4, wherein the support comprises a gripping means configured to be gripped by toes.

9. The apparatus of claim 8 wherein the gripping means comprise protrusions or extrusions in the support at one or more sides of where the apparatus body is fixed to the support.

10. The apparatus of claim 1, wherein a cross-sectional profile of the apparatus body comprises a semi triangular or Reuleaux triangle.

11. The apparatus of claim 4, wherein the support comprises a structure defined by at least two surfaces joined in a fixed or manipulatable angle therebetween and configured to stretch a sole of a foot.

12. The apparatus of claim 1, wherein at least two of the curvilinear outer surfaces of the apparatus body are different from each other by having different curvilinear trajectories.

13. The apparatus of claim 1, wherein the three curvilinear outer surfaces of the apparatus body are different from each other by each of the three curvilinear outer surfaces having different curvilinear trajectories.

14. The apparatus of claim 1 wherein at least two of the three or more edges of the apparatus body have a different roundness.

15. The apparatus of claim 1, wherein each of the three or more edges of the apparatus body have a different roundness.
